(19) United States
(12) Patent Application Publication
(10) Pub. No.: US 2015/0135520 A1
(43) Pub. Date: May 21, 2015

(54) METHOD OF MANUFACTURING ROTATING DEVICE

(71) Applicant: Samsung Electro-Mechanics Japan Advanced Technology Co., Ltd., Shizuoka (JP)

(72) Inventor: Mitsuhiro AONO, Shizuoka (JP)

(21) Appl. No.: 14/535,563

(22) Filed: Nov. 7, 2014

(30) Foreign Application Priority Data
Nov. 15, 2013 (JP) 2013-237366

(51) Int. Cl. G11B 33/14; G11B 5/105

(52) U.S. Cl. CPC G11B 33/1446; G11B 5/105
USPC 29/603.03

(57) ABSTRACT

A method of manufacturing a rotating device, includes assembling a rotor part on a chassis in a rotatable manner, supplying a fluid mixture including solidified carbon dioxide onto the rotor part and the chassis from a nozzle which moves relative to the chassis having the rotor part assembled thereon, and packaging the chassis having the rotor part assembled thereon within a package after the supplying.

### CROSS-REFERENCE TO RELATED APPLICATIONS

This application is based upon and claims the benefit of priority of Japanese Patent Application No. 2013-237366 filed on Nov. 15, 2013, the entire contents of which are incorporated herein by reference.

### BACKGROUND OF THE INVENTION

1. Field of the Invention

The present invention relates to a method of manufacturing a rotating device.

2. Description of the Related Art

A disk drive unit, such as an HDD (Hard Disk Drive), for example, is one type of rotating device. The reduction in size and the increase in storage capacity of the disk drive unit have enabled the disk drive unit to be provided not only in desk-top personal computers, but also in various electronic apparatuses including lap-top personal computers, video recording apparatuses, or the like.

There are demands to further reduce the size and further increase the storage capacity of the disk drive unit, due to large-capacity contents such as high-definition videos or the like. As a method of reducing the size and increasing the storage capacity of the disk drive unit, there is a technique that narrows a recording track width, and arranges a magnetic head close to a surface of a magnetic recording disk.

In the disk drive unit, foreign particles adhered on components forming the disk drive unit may become loose due to vibrations or the like and adhere onto the magnetic recording disk. In addition, the foreign particles may adhere onto the magnetic recording disk by vaporization and recondensation. When the foreign particles adhere onto the magnetic recording disk, a read/write error may be generated.

When the recording track width is reduced as described above, the foreign particles become large relative to the recording track width, and thus, undesirable effects on the read/write operation become more conspicuous when compared to a conventional case in which the recording track width is not reduced. When a gap between the magnetic head and the disk surface is narrow, the foreign particles adhered on the magnetic recording disk more easily interfere the magnetic head, and the undesirable effects on the read/write operation similarly become more conspicuous. In other words, even in the case of the small foreign particles which are conventionally tolerated, or in the case of the small amount of foreign particles which are conventionally tolerated, such foreign particles have an increased possibility of introducing undesirable effects on the operation of the disk drive unit having the reduced size and the increased storage capacity.

For example, Japanese Laid-Open Patent Publication No. 2011-123984 proposes a method of manufacturing a disk unit, in which a subassembly that includes a bearing unit and a drive unit assembled on a base member is subjected to cleaning, sealing, or the like during a manufacturing process of the disk drive unit. As a result, cleanliness of the disk drive unit is improved, and the possibility of generating malfunction is reduced.

In order to further reduce the size and further increase the storage capacity of the disk drive unit, the cleanliness of the disk drive unit needs to be further improved. However, according to the conventional method of manufacturing the disk drive unit, a cleaning time needs to be increased in order to further improve the cleanliness of the disk drive unit, but the increased cleaning time may increase the manufacturing cost and deteriorate the productivity of the disk drive unit.

### SUMMARY OF THE INVENTION

Embodiments of the present invention may provide a method of manufacturing a rotating device that can remove foreign particles adhered on components forming the rotating device, in order to further improve the cleanliness of the rotating device.

According to one aspect of the present invention, a method of manufacturing a rotating device may include assembling a rotor part on a chassis in a rotatable manner; supplying a fluid mixture including solidified carbon dioxide onto the rotor part and the chassis from a nozzle which moves relative to the chassis having the rotor part assembled thereon; and packaging the chassis having the rotor part assembled thereon within a package after the supplying.

According to another aspect of the present invention, a method of manufacturing a rotating device may include assembling a rotor part on a chassis in a rotatable manner; supplying a fluid mixture including solidified carbon dioxide onto the rotor part and the chassis from a nozzle which moves relative to the chassis having the rotor part assembled thereon; and collecting, under suction, a gas or gases in vicinities of the chassis and the rotor part.

According to still another aspect of the present invention, a method of manufacturing a rotating device may include assembling a rotor part on a chassis in a rotatable manner; and supplying a fluid mixture including solidified carbon dioxide onto the rotor part and the chassis from a nozzle which moves relative to the chassis having the rotor part assembled thereon, wherein the supplying supplies the fluid mixture while rotating the rotor part.

Other objects and further features of the present invention may be apparent from the following detailed description when read in conjunction with the accompanying drawings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are diagrams schematically illustrating an example of a general configuration of a rotating device in one embodiment;

FIG. 2 is a cross sectional view schematically illustrating a cross section along a line A-A in FIG. 1A;

FIG. 3 is a flow chart for explaining an example of a method of manufacturing a rotating device in one embodiment;

FIG. 4 is a side view schematically illustrating an example of a configuration of a cleaning apparatus;

FIG. 5 is a front view schematically illustrating the example of the configuration of the cleaning apparatus;

FIG. 6 is a block diagram illustrating an example of a configuration of a fluid mixture producing apparatus;

FIG. 7 is a diagram for explaining a cleaning method A;

FIG. 8 is a diagram illustrating an example of cleaning results in a practical example Emb1;

FIG. 9 is a diagram for explaining locations of each of parts included in the cleaning results illustrated in FIG. 8;

FIG. 10 is a diagram for explaining a cleaning method B;

FIG. 11 is a a diagram illustrating an example of cleaning results in a practical example Emb2;

FIG. 12 is a diagram for explaining locations of each of parts included in the cleaning results illustrated in FIG. 11; and

FIG. 13 is a diagram schematically illustrating another example of the configuration of the cleaning apparatus.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

In the following description, a rotating device in one embodiment can be mounted with a magnetic recording disk that magnetically records data, and may be used as an HDD or the like.

### Configuration of Rotating Device

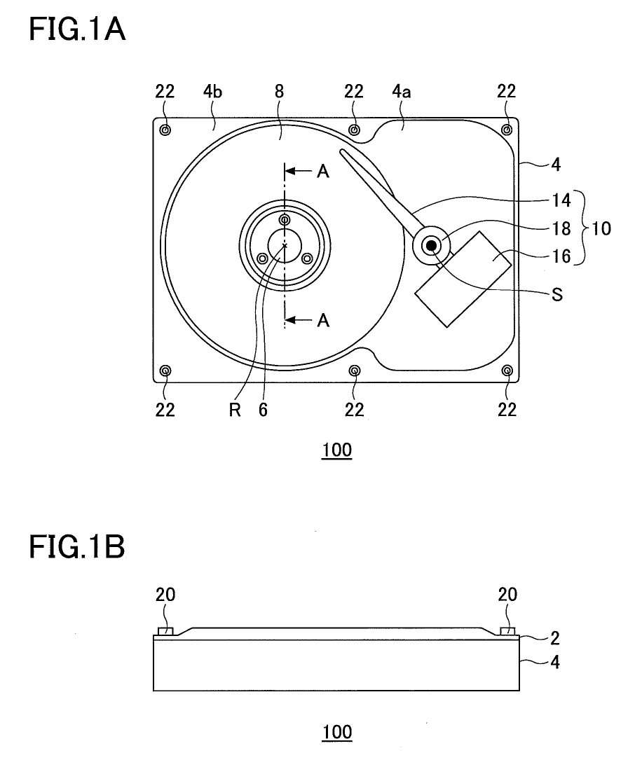

A description will be given of a rotating device 100, which is one type of a rotating device, in one embodiment of the present invention, by referring to FIGS. 1A and 1B. FIGS. 1A and 1B are diagrams schematically illustrating an example of a general configuration of a rotating device in one embodiment. FIG. 1A illustrates a plan view of the rotating device 100, and FIG. 1B illustrates a side view of the rotating device 100.

The rotating device 100 includes a top cover 2, a chassis 4, a rotor 6, a magnetic recording disk 8, and a data read and/or write unit (hereinafter simply referred to as “data read/write unit”) 10.

In the following description, in a state in which the top cover 2 is mounted on the chassis 4, the side of the top cover 2 is referred to as an “upper side”, and the side of the chassis 4 is referred to as a “lower side”. In addition, a direction parallel to a rotational axis R of the magnetic recording disk 8 is referred to as an “axial direction”, and an arbitrary direction passing through the rotational axis R on a plane perpendicular to the rotational axis R is referred to as a “radial direction”. Further, the side further away from the rotational axis R along the radial direction is referred to as an “outer peripheral side”, and the side closer to the rotational axis R along the radial direction is referred to as an “inner peripheral side”. These sides and directions do not limit an orientation of the rotating device 100 in use, and the rotating device 100 may be used in an arbitrary orientation.

### (Top Cover)

The top cover 2 is formed by pressing an aluminum plate or a steel plate, for example. The top cover 2 may be subjected to a surface treatment such as plating or the like, for example, in order to prevent corrosion. The top cover 2 is fixed on an upper surface of the chassis 4 by screws 20 located in a periphery of the top cover 2. The top cover 2 and the chassis 4 are fixed so as to seal the inside of the rotating device 100.

### (Chassis)

The chassis 4 includes a bottom surface 4a forming a bottom part of the rotating device 100, and an outer peripheral wall 4b that is formed along an outer periphery of the bottom surface 4a to surround a setting region in which the magnetic recording disk 8 is set. Screw holes 22 are provided in an upper surface of the outer peripheral wall 4b, and the screws 20 are screwed into the screw holes 22.

The top cover 2 is fixed on the upper surface of the outer peripheral wall 4b of the chassis 4 by the screws 20. A disk accommodating space surrounded by the bottom surface 4a and the outer peripheral wall 4b of the chassis 4 and the top cover 2 is sealed and isolated from external environment, and is filled with clean air that is removed of dust or the like. Accordingly, adhesion of foreign particles such as dust or the like onto the magnetic recording disk 8 can be suppressed, and the possibility of a malfunction caused by the foreign particles occurring in the rotating device 100 can be reduced.

The chassis 4 is formed by die casting using an aluminum alloy, or pressing a metal plate using stainless steel, aluminum, or the like, for example. In the case of pressing, embossing may be performed to form projections on the upper side of the chassis 4. By performing embossing at predetermined parts of the chassis 4, deformation of the chassis 4 can be suppressed.

In addition, the chassis 4 may have a surface treated layer, such as a plated layer made of a metal material such as nickel, chromium, or the like, or a coated layer made of a resin material such as epoxy resin or the like. By providing such a surface treated layer, surface peeling of the chassis 4 can be prevented. Moreover, even when the magnetic recording disk 8 or the like makes contact with the surface of the chassis 4 during the manufacturing process, for example, the possibility of damaging the surface of the chassis 4, the magnetic recording disk 8, or the like can be reduced. Furthermore, compared to the coated layer made of the resin material, the plated layer made of the metal material can increase the surface hardness of the chassis 4 and also reduce the coefficient of friction, and thus, the possibility of damaging the surface of the chassis 4, the magnetic recording disk 8, or the like upon contact can further be reduced.

### (Data Read/Write Unit)

The data read/write unit 10 includes a recording and reproducing head (not illustrated), a swing arm 14, a voice coil motor 16, and a pivot assembly 18. The recording and reproducing head is mounted on a tip end part of the swing arm 14, and is configured to record data on the magnetic recording disk 8, and to read data from the magnetic recording disk 8. The pivot assembly 18 pivotally supports the swing arm 14 to freely swing about a head rotational axis S as its center of swing. The voice coil motor 16 swings the swing arm 14 about the head rotational axis S as its center of swing, and moves the recording and reproducing head to a desired position on the surface of the magnetic recording disk 8. The voice coil motor 16 and the pivot assembly 18 may be formed using a known technique to control the position of the recording and reproducing head.

### (Magnetic Recording Disk)

The magnetic recording disk 8 may be formed by a 2.5-inch magnetic recording disk made of glass having a diameter of 65 mm, a thickness of 0.65 mm, and a center hole having diameter of 20 mm. In the rotating device 100 in this embodiment, one magnetic recording disk 8 is mounted on an outer periphery of the rotor 6, and this magnetic recording disk 8 rotates together with the rotor 6 that is rotationally driven.

### Configuration of Bearing Mechanism

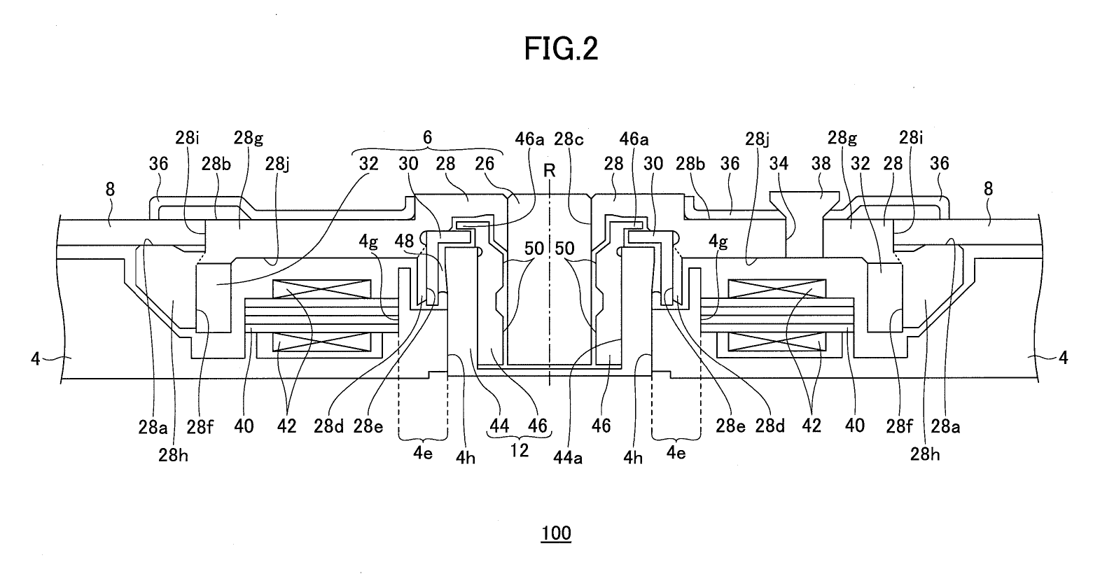

FIG. 2 is a cross sectional view schematically illustrating a cross section along a line A-A in FIG. 1A. FIG. 2 illustrates an example of a bearing mechanism of the rotating device 100 in this embodiment.

The rotating device 100 includes a stationary body (hereinafter also referred to as a “stator part”) and a rotating body (hereinafter also referred to as a “rotor part”). The stator part includes the chassis 4, a bearing unit 12, a stator core 40, and a coil 42. On the other hand, the rotor part includes a shaft 26, a hub 28, a thrust member 30, and a cylindrical magnet 32.

In the rotating device 100, a lubricant 48 fills a gap between the rotor 6 and the bearing unit 12. The rotor part including the rotor 6 mounted with the magnetic recording disk 8 is supported by the stator part including the bearing unit 12 to freely rotate.

### (Bearing Unit)

The bearing unit 12 includes a housing 44 and a sleeve 46, and rotatably supports the rotor 6.

The housing 44 is formed to an approximate cup-shape having a recess 44a that opens upwards about the rotational axis R as its center. The housing 44 is fixed by being press-fit, for example, into a penetration hole 4h of the chassis 4, provided along the rotational axis R of the rotor 6.

The sleeve 46 has a hollow cylindrical shape, and is fixed by being press-fit, for example, into the recess 44a of the housing 44. A flange part 46a is provided at the upper end of the sleeve 46 and extends towards the outer side in the radial direction. The flange part 46a cooperates with the thrust member 30 in order to restrict movement of the hub 28 in the axial direction.

### (Stator Core)

The stator core 40 includes a ring-shaped part, and twelve (12) salient poles extending from the ring-shaped part on the outer peripheral side. The stator core 40 is fixed by being press-fit or loosely fitted on an outer peripheral surface 4g of a ring-shaped wall part 4e that projects in a cylindrical shape from the bottom surface of the chassis 4. The stator core 40 is formed by stacking four (4) thin electromagnetic steel plates into a single plate member by caulking, for example. The surface of the stator core 40 is subjected to an insulator coating, such as electro-coating, powder coating, or the like. The coil 42 is wound on each salient pole of the stator core 40. A driving magnetic flux is generated along the salient poles when a 3-phase driving current having an approximately sinusoidal waveform flows to the coil 42. The stator core 40 may be a solid core formed by solidifying magnetic powder such as sintered compact.

### (Hub)

The hub 28 may be made of a soft magnetic steel material such as SUS430F, for example. The hub 28 may be formed into the approximate cup-shape by cutting the steel material, for example. The steel material forming the hub 28 may be added with a component such as Mn, S, Te, Pb, or the like, for example, in order to improve the machinability of the cutting.

The hub 28 includes a shaft hole 28c, a hub projecting part 28g, a setting part 28h provided on the outer side than the hub projecting part 28g in the radial direction, and a downwardly extending part 28d that projects downwardly from a lower surface 28j of the hub projecting part 28g and surrounds the bearing unit 12. The hub 28 in this embodiment is formed from a single member, however, the hub 28 may be formed from a plurality of members.

The magnetic recording disk 8 is fitted on an outer peripheral surface 28i of the hub projecting part 28g, and is placed on a disk setting surface 28a formed by an upper surface of the setting part 28h.

### (Shaft)

An upper end part of the shaft 26 is fixed by being press-fit, for example, into the shaft hole 28c of the hub 28, and a lower end part of the shaft 26 is surrounded by the sleeve 46. The shaft 26 is rotatably supported together with the hub 28. The shaft 26 may be made of a steel material such as SUS420J2, for example.

### (Clamper)

A clamper 36 is fixed to the hub 28 so as to sandwich the magnetic recording disk 8 between the disk setting surface 28a and the clamper 36, by disk fixing screws 38 that are screwed into disk fixing screw holes 34 provided in an upper surface 28b of the hub projecting part 28g.

### (Thrust Member)

The thrust member 30 is a ring-shaped member that is fixed to an inner peripheral surface 28e of the downwardly extending part 28d of the hub 28 by an adhesive or the like. A displacement of the hub 28 in the axial direction is prevented by the thrust member 30 that is interposed between the flange part 46a of the sleeve 46 and the housing 44.

### (Cylindrical Magnet)

The cylindrical magnet 32 is fixed to an inner peripheral surface 28f of the setting part 28h of the hub 28 by an adhesive, for example. The cylindrical magnet 32 may be made from a ferrite magnetic material, a rare earth magnetic material, or the like, for example, and may include a binder made of a resin such as polyamide. In addition, the cylindrical magnet 32 may have a stacked structure formed by a ferrite magnetic layer and a rare earth magnetic layer.

The cylindrical magnet 32 is magnetized to have twelve (12) poles, for example, along a circumferential direction of an inner peripheral surface thereof, and opposes the outer peripheral surface of the salient poles provided on the stator core 40 via a gap in the radial direction.

### (Lubricant And Dynamic Pressure Generating Groove)

A lubricant 48 is provided in a space between a first group of elements including the shaft 26 of the rotor 6, the hub 28, and the thrust member 30, and a second group of elements including the housing 44 of the bearing unit 12 and the sleeve 46. The bearing unit 12 rotatably supports the rotor 6 via the lubricant 48.

A pair of radial dynamic pressure generating grooves 50 having a herringbone shape or a spiral shape, for example, and separated in the up-and-down direction, is formed in the inner peripheral surface of the sleeve 46. In addition, a thrust dynamic pressure generating groove having a herringbone shape or a spiral shape, for example, is formed in the thrust member 30 at a part opposing the flange part 46a of the sleeve 46 and at a part opposing the upper surface of the housing 44. When the rotor 6 rotates, these radial dynamic pressure generating grooves 50 and the thrust dynamic pressure generating grooves generate dynamic pressure in the lubricant 48, and the rotor 6 is supported in the radial direction and in the axial direction by the dynamic pressure generated in the lubricant 48.

The radial dynamic pressure generating grooves 50 may be formed in the outer peripheral surface of the shaft 26. Further, the thrust dynamic pressure generating grooves may be formed in the lower surface of the flange part 46a of the sleeve 46 and in the upper surface of the housing 44, respectively.

The configuration of the rotating device 100 in this embodiment is described above, however, the configuration is not limited to that in this embodiment, as long as the rotor part which is set with the magnetic recording disk 8 and rotates is rotatably supported on the stator part including the chassis 4 or the like. For example, although the shaft 26 rotates in the rotating device 100 which is a shaft rotating type, the rotating device may be a shaft fixed type having constituent elements different from those of the shaft rotating type rotating device 100.

### Method of Manufacturing Rotating Device

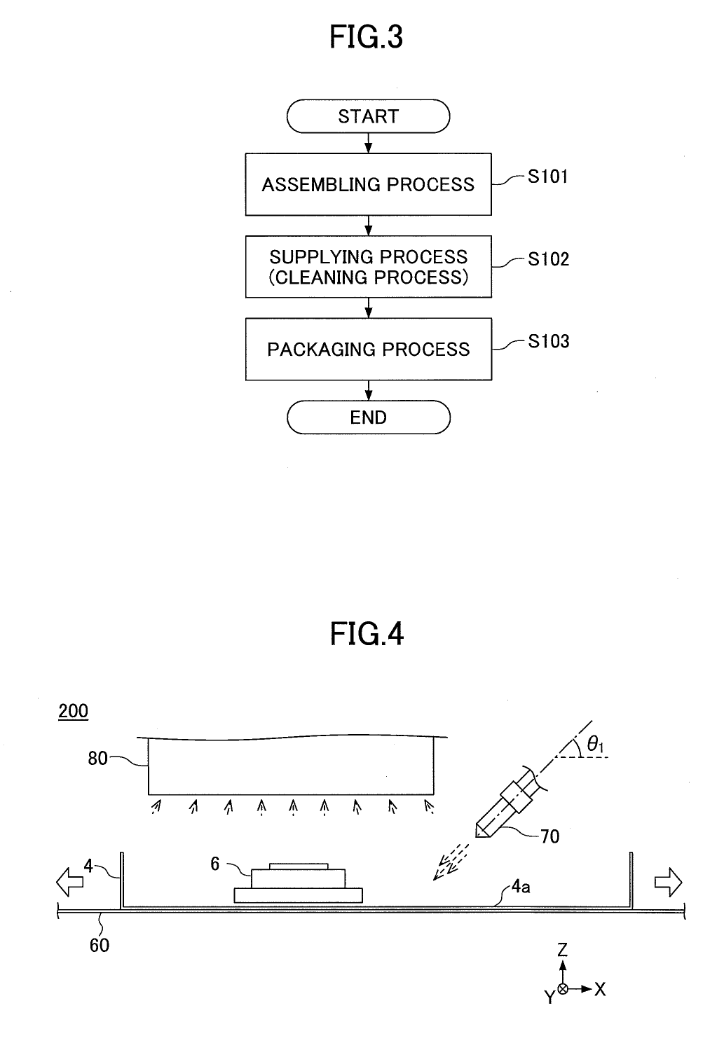

FIG. 3 is a flow chart for explaining an example of a method of manufacturing the rotating device 100 in one embodiment.

As illustrated in FIG. 3, the bearing unit 12 and the rotor 6 are assembled on the chassis 4 of the rotating device 100 in an assembling process of step S101. The lubricant 48 is provided between the first group of elements including the shaft 26 of the rotor 6, the hub 28, and the thrust member 30, and the second group of elements including the housing 44 of the bearing unit 12 and the sleeve 46. The rotor 6 is assembled to be freely rotatable with respect to the chassis 4.

The present inventor studied the cleanliness of the rotating device 100, and recognized the following.

(1) There are two cases, namely, a first case in which foreign particles adhere on constituent elements of the rotating device 100 before the assembling process of step S101, and a second case in which the foreign particles adhere on the constituent elements of the rotating device 100 during the assembling process of step S101.

(2) When the second case is considered, even if the rotating device 100 is assembled using the rotor 6, the chassis 4, or the like that have been cleaned in advance to remove the foreign particles, the cleanliness of the rotating device 100 may deteriorate due to foreign particles that adhere on the constituent elements of the rotating device 100 during the assembling process of step S101.

(3) Accordingly, in order to improve the cleanliness of the rotating device 100, it is effective to perform a cleaning process to clean the rotor 6, the chassis 4, or the like to remove the foreign particles after the assembling process of step S101.

(4) Further, it is desirable to perform a packaging process to contain the rotating device 100 within a package such as a plastic bag, for example, as soon as possible after the cleaning process.

Next, a fluid mixture including solidified carbon dioxide is supplied from a nozzle that moves relative to the chassis 4, the rotor 6, or the like in order to remove the foreign particles such as dust or the like adhered on the chassis 4, the rotor 6, or the like in a supplying process (or cleaning process) of step S102, in order to clean the chassis 4, the rotor 6, or the like. In this specification, “to supply a fluid mixture” includes any one of or a combination of spraying the fluid mixture, blowing the fluid mixture, blasting the fluid mixture, applying the fluid mixture, or the like. A description on a cleaning apparatus and a cleaning method used to clean the chassis 4, the rotor 6, or the like will be given later.

Next, the chassis 4, the rotor 6, or the like that have been cleaned and removed of the foreign particles such as dust or the like are contained within the package such as the plastic bag, for example, and air within the package is drawn out to decompress the inside of the sealed package to a state close to vacuum, in the packaging process of step S103. The package containing the chassis 4, the rotor 6, or the like is transported to and opened at a assembling location where the magnetic recording disk 8 is fixed to the hub 28 by the clamper 36, and the top cover 2 is assembled onto the upper surface of the chassis 4 in order to assemble the rotating device 100.

The foreign particles such as dust or the like adhered on the chassis 4, the rotor 6, or the like after the assembling process of step S101 are removed by the supplying process (or cleaning process) of step S102. Hence, it is possible to reduce the possibility of a malfunction caused by the foreign particles adhered on the chassis 4, the rotor 6, or the like from occurring in the rotating device 100.

### (Cleaning Apparatus)

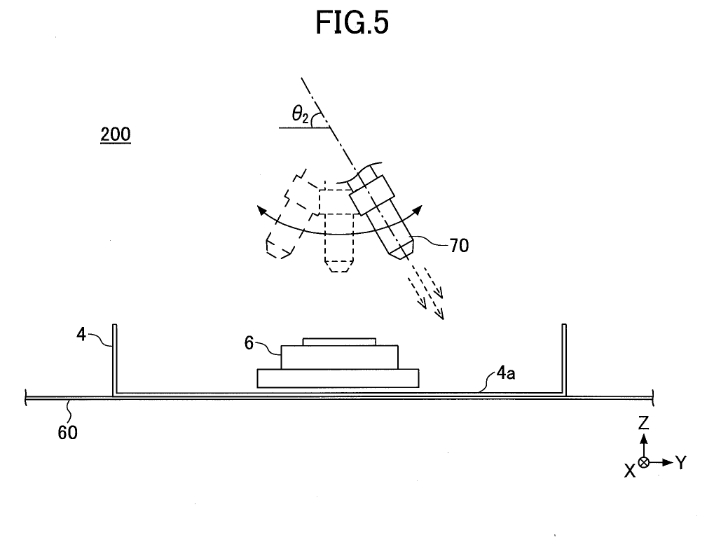

FIGS. 4 and 5 schematically illustrate an example of a configuration of a cleaning apparatus 200 which cleans the chassis 4, the rotor 6, or the like. More particularly, FIG. 4 is a side view schematically illustrating the example of the configuration of the cleaning apparatus 200, and FIG. 5 is a front view schematically illustrating the example of the configuration of the cleaning apparatus 200.

The cleaning apparatus 200 includes a transport belt 60 that transports the chassis 4 having the rotor 6 assembled thereon, a nozzle 70 that supplies the fluid mixture with respect to the chassis 4, the rotor 6, or the like, and a particle collecting unit 80 that collects the foreign particles removed from the chassis 4, the rotor 6, or the like.

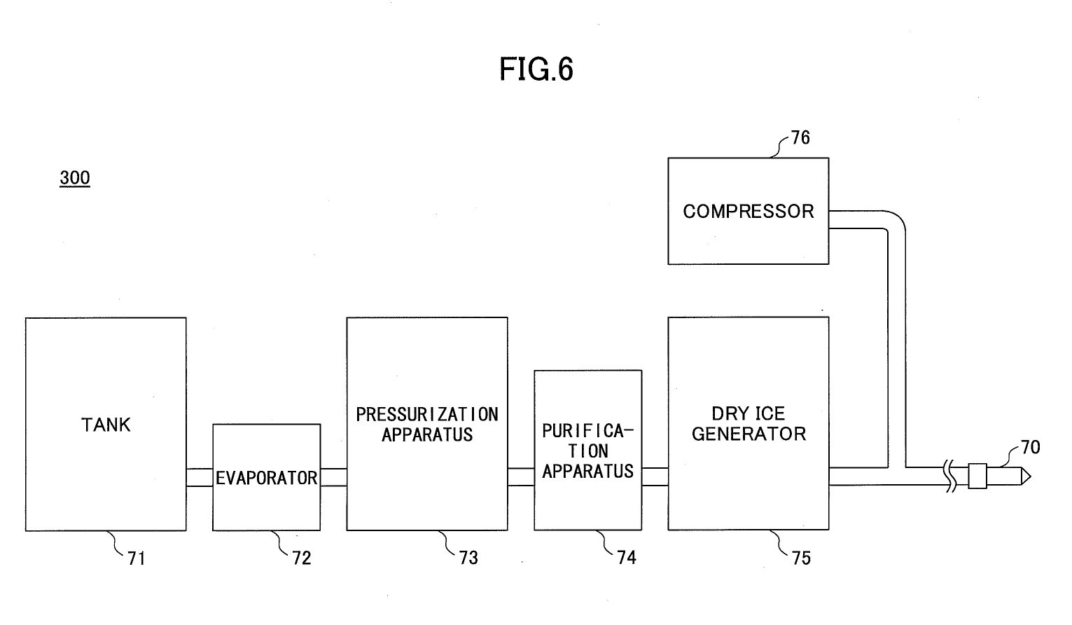

In FIGS. 4 and 5, an X-axis direction is a transport direction of the chassis 4, the rotor 6, or the like. A Y-axis direction is a direction perpendicular to the X-axis direction on a surface of the transport belt 60. A Z-axis direction is a direction parallel to the rotational axis R of the rotor 6. In FIG. 6, the illustration of the particle collecting unit 80 is omitted for the sake of convenience.

The chassis 4 having the rotor 6 or the like assembled thereon is set on the surface of the transport belt 60, and the transport belt 60 is driven by a driving mechanism (or driving means, not illustrated) to move the chassis 4, the rotor 6, or the like in the X-axis direction. For example, the chassis 4 having the rotor 6 or the like assembled thereon is moved from left to right in FIG. 4, or from right to left in FIG. 4.

The nozzle 70 supplies the fluid mixture produced by a fluid mixture producing apparatus with respect to the chassis 4, the rotor 6, or the like, in order to remove the foreign particles such as dust or the like adhered on the chassis 4, the rotor 6, or the like. The fluid mixture supplied from the nozzle 70 may include particles (or microparticles) of solidified carbon dioxide, or dry ice.

The particles of dry ice adhere on the foreign particles such as dust existing on the surfaces of the chassis 4, the rotor 6, or the like, and remove the foreign particles as vaporization and expansion of the particles of dry ice cause the foreign particles to disengage and disperse from the surfaces of the chassis 4, the rotor 6, or the like.

The nozzle 70 is configured to supply the fluid mixture in an arbitrary direction with respect to the bottom surface 4a of the chassis 4. For example, in order to effectively supply the fluid mixture on the upper surface of the chassis 4, the nozzle 70 preferably supplies the fluid mixture in the direction non-parallel with respect to the bottom surface 4a of the chassis 4. In addition, in order to effectively supply the fluid mixture on the side surface of the chassis 4, the nozzle 70 preferably supplies the fluid mixture in the direction non-perpendicular with respect to the bottom surface 4a of the chassis, 4. From the viewpoint of effectively supplying the fluid mixture on the upper and side surfaces of the chassis 4, an angle θ₁ illustrated in FIG. 4, formed between the X-axis direction and the direction in which the nozzle 70 supplies the fluid mixture, is preferably in a range of 10° or greater and 80° or smaller, and more preferably in a range of 30° or greater and 60° or smaller.

In addition, from the viewpoint of uniformly supplying the fluid mixture on each part of the chassis 4 having the rotor 6 or the like assembled thereon, the direction in which the nozzle 70 supplies the fluid mixture may be inclined with respect to at least one of the Y-axis direction and the Z-axis direction. For example, as illustrated in FIG. 5, the direction in which the nozzle 70 supplies the fluid mixture may be inclined with respect to the Y-axis direction. An angle θ₂ illustrated in FIG. 5, formed between the Y-axis direction and the direction in which the nozzle 70 supplies the fluid mixture, is preferably in a range of 10° or greater and 80° or smaller, and more preferably in a range of 30° or greater and 60° or smaller. In addition, an angle θ₃ (not illustrated in FIG. 5), formed between the Z-axis direction and the direction in which the nozzle 70 supplies the fluid mixture, is preferably in a range of 10° or greater and 80° or smaller, and more preferably in a range of 30° or greater and 60° or smaller. Further, the nozzle 70 may be configured to swing while the chassis 4 is transported by the transport belt 60, so that the direction in which the nozzle 70 supplies the fluid mixture changes as indicated by a solid line arrow in FIG. 5.

Accordingly, by providing the nozzle 70 that supplies the fluid mixture in the direction both non-parallel and non-perpendicular with respect to the bottom surface 4a of the chassis 4, it becomes possible to remove the foreign particles such as dust from the inner surface of the outer peripheral wall 4b of the chassis 4, the entire rotor 6 having a complex shape, or the like. Of course, the number of nozzles 70 that are provided is not limited to one, and a plurality of nozzles 70 may be provided.

The particle collecting unit 80 is provided above the chassis 4 that is transported on the transport belt 60, and collects the foreign particles removed by the fluid mixture supplied from the nozzle 70. Because the removed foreign particles such as dust are collected by the particle collecting unit 80, the removed foreign particles will not adhere again onto the chassis 4, the rotor 6, or the like. The particle collecting unit 80 may collect the foreign particles by suction, for example.

In this embodiment, the chassis 4 having the rotor 6 or the like assembled thereon is transported on the transport belt 60 and moves with respect to the nozzle 70. In other words, the chassis 4 is moved with respect to the nozzle 70 that is stationary. However, the nozzle 70 may be moved with respect to the chassis 4 that is stationary. Furthermore, both the chassis 4 and the nozzle 70 may be moved to effectively supply the fluid mixture on various parts of the chassis 4.

### (Fluid Producing Apparatus)

FIG. 6 is a block diagram illustrating an example of a configuration of a fluid mixture producing apparatus 300 that produces the fluid mixture supplied onto the chassis 4, the rotor 6, or the like from the nozzle 70 of the cleaning apparatus 200.

The fluid mixture producing apparatus 300 includes a tank 71, an evaporator 72, a pressurization apparatus 73, a purification apparatus 74, a dry ice generator 75, and a compressor 76.

The tank 71 stores liquefied carbon dioxide at a temperature of −20° C. and a pressure of 2 MPa, for example. The evaporator 72 heats and vaporizes the liquefied carbon dioxide stored in the tank 71. The pressurization apparatus 73 pressurizes the carbon dioxide gas vaporized by the evaporator 72. The pressurization apparatus 73 pressurizes the carbon dioxide gas having a pressure of 1.5 MPa to a pressure of 6 MPa, for example.

The purification apparatus 74 purifies the carbon dioxide gas by using a filter or the like to remove hydrogen, oxygen, nitrogen, and other impurities included in the carbon dioxide gas, for example, in order to purify the carbon dioxide gas. The dry ice generator 75 pressurizes the carbon dioxide gas to again liquefy the carbon dioxide gas and thereafter releases the liquefied carbon dioxide to the atmosphere (that is, air at atmospheric pressure), in order to generate dry ice particles (or dry ice powder) having a particle size of 5 μm to 50 μm, for example. The dry ice particles generated by the dry ice generator 75 are supplied to the nozzle 70. The compressor 76 compresses gas, such as purified air, and supplies the compressed gas to the nozzle 70.

The nozzle 70 supplies the fluid mixture that includes the compressed gas (or purified air) supplied from the compressor 76 and the dry ice particles supplied from the dry ice generator 75. Hence, at least a part of the dry ice particles reaches the chassis 4, the rotor 6, or the like in the solidified state. In order to prevent condensation caused by cooling of the dry ice adhered on the chassis 4, the rotor 6, or the like, the gas supplied form the compressor 76 may be heated to a temperature in a range of 60° C. to 90° C., for example. In addition, at least one of the chassis 4, the rotor 6, or the like may be heated to the temperature in the range of 60° C. to 90° C., for example. Alternatively, at least one of the gas supplied from the compressor 76, the chassis 4, the rotor 6, or the like may be heated.

### Practical Example Emb1

Next, a description will be given of the cleaning method in a practical example Emb1 in which the supplying process supplies the fluid mixture from the nozzle 70 of the cleaning apparatus 200 in order to remove the foreign particles from the chassis 4, the rotor 6, or the like.

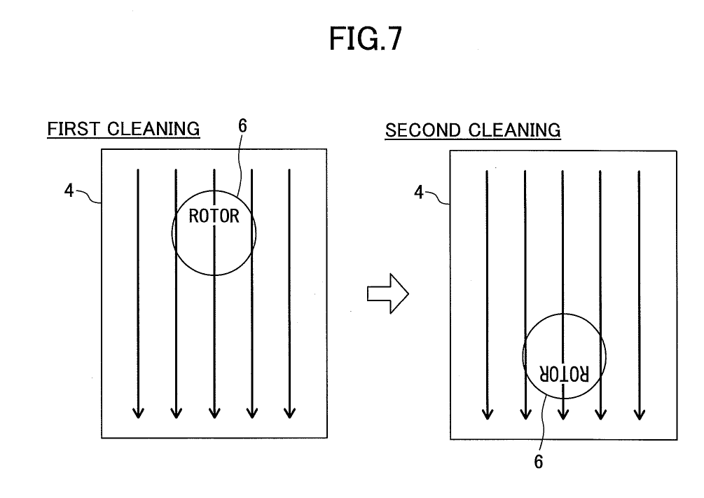

In the practical example Emb1, the chassis 4, the rotor 6, or the like are cleaned by a cleaning method A illustrated in FIG. 7. FIG. 7 is a diagram for explaining the cleaning method A. In FIG. 7, a relative moving direction of the nozzle 70 with respect to the chassis 4, the rotor 6, or the like is indicated by solid line arrows.

As illustrated in FIG. 7, the cleaning method A performs the cleaning twice. At each cleaning, the nozzle 70 moves linearly in the moving direction relative to the chassis 4, while performing a supplying operation to supply the fluid mixture from one end to the other end of the chassis 4, and such a supplying operation is performed five (5) times by changing the position of the nozzle 70 at 20 mm intervals in the direction perpendicular to the moving direction.

When the first cleaning performed in the above described manner as illustrated on the left side of FIG. 7 ends, the chassis 4 is turned 180° so that the nozzle 70 moves relative to the chassis 4 in a direction opposite to the moving direction at the time of the first cleaning. A second cleaning illustrated on the right side of FIG. 7 is then performed in this state in which the chassis 4 is turned 180°, and the supplying operation is performed five (5) times by changing the position of the nozzle 70 at 20 mm intervals in the direction perpendicular to the moving direction, similarly as in the case of the first cleaning.

In this practical example Emb1, the angle θ₁ illustrated in FIG. 4 of the nozzle 70 is 45°, a distance between the nozzle 70 and the chassis 4 is 20 mm, a supplying width (for example, spraying width) of the nozzle 70 is 50 mm, the flow rate of the fluid mixture supplied from the nozzle 70 is 300 L/min, the gas (or air) pressure of the gas supplied from the compressor 76 is 0.5 MPa, and the temperature of the fluid mixture supplied onto the chassis 4, the rotor 6, or the like is in a range of 78° C. to 80° C.

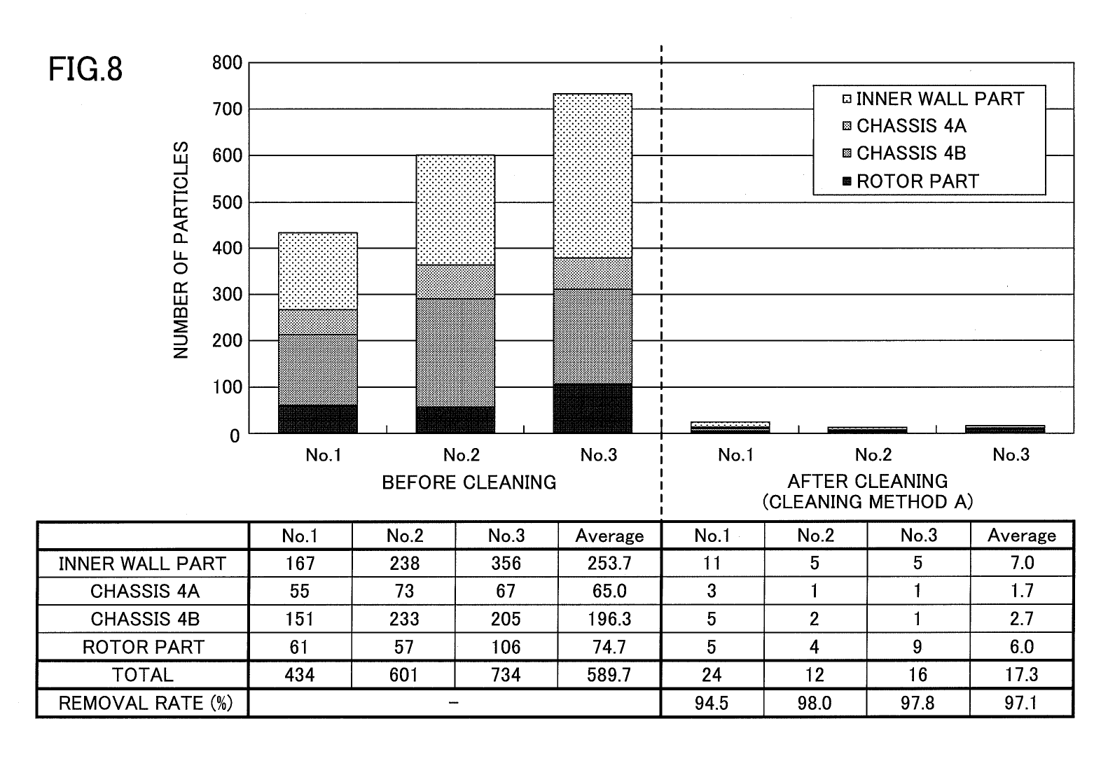

FIG. 8 is a diagram illustrating an example of cleaning results obtained in the practical example Emb1.

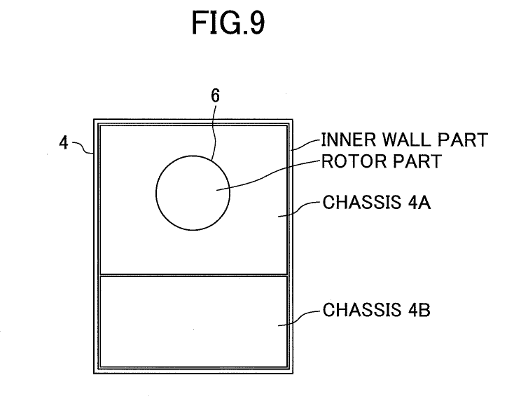

FIG. 8 illustrates, for sample No. 1, sample No. 2, and sample No. 3, the number of foreign particles adhered thereon before and after the cleaning using the cleaning method A described above. Each of the sample Nos. 1 through 3 correspond to the chassis 4 having the rotor 6 assembled thereon but not yet having the top cover 2 provided thereon. The number of foreign particles indicated in the cleaning results are obtained by counting the number of foreign particles at each of the inner surface (or inner wall part) of the outer peripheral wall 4b of the chassis 4, the entire rotor 6 (or rotor part), the space (or chassis 4A) of the chassis 4 on the side of the rotor 6, and the space (or chassis 4B) of the chassis 4 on the side of the data read/write unit 10, as illustrated in FIG. 9. FIG. 9 is a diagram for explaining locations of each of parts included in the cleaning results illustrated in FIG. 8.

As illustrated in FIG. 8, the total number of foreign particles on an average is 589.7 (inner wall part: 253.7, chassis 4A: 65, chassis 4B: 196.3, rotor part: 74.7) for each of the sample Nos. 1 through 3 before the cleaning. On the other hand, the total number of foreign particles on an average is 17.3 (inner wall part: 7, chassis 4A: 1.7, chassis 4B: 2.7, rotor part: 6) for each of the sample Nos. 1 through 3 after the cleaning using the cleaning method A illustrated in FIG. 7, and the number of foreign particles is reduced after the cleaning.

Hence, according to the practical example Emb1, the removal rate of the foreign particles adhered on each of the sample Nos. 1 through 3 is approximately 97%, and it is confirmed that the foreign particles adhered on the chassis 4, the rotor 6, or the like are effectively removed and the cleanliness is improved.

### Practical Example Emb2

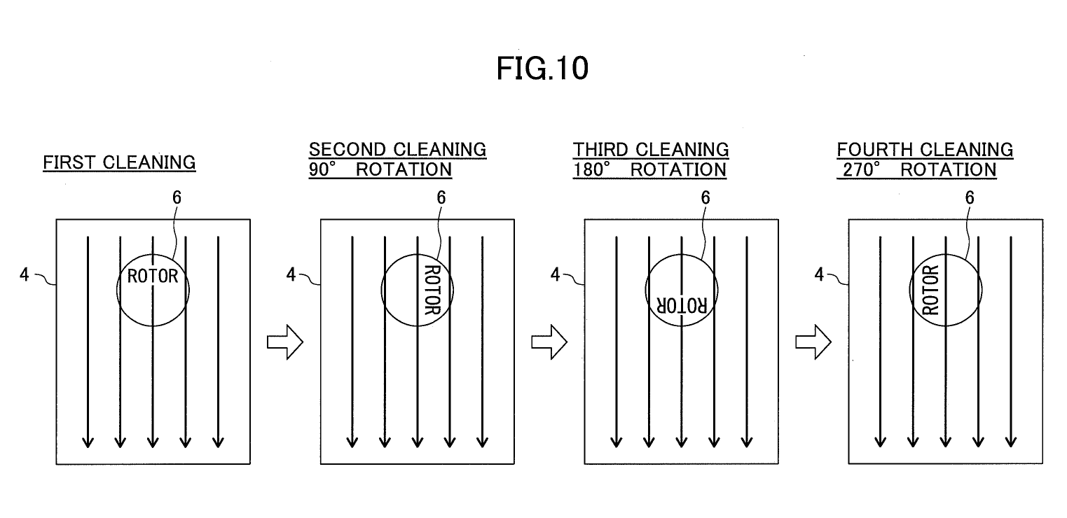

Next, a description will be given of the cleaning method in a practical example Emb2 in which the chassis 4, the rotor 6, or the like are cleaned by the cleaning method A described above in conjunction with FIG. 7, and the rotor 6 is thereafter cleaned in particular by a cleaning method B to be described with reference to FIG. 10. FIG. 10 is a diagram for explaining the cleaning method B. In FIG. 10, a relative moving direction of the nozzle 70 with respect to the chassis 4, the rotor 6, or the like is indicated by solid line arrows.

As illustrated in FIG. 10, the cleaning method B performs the cleaning four times. At each cleaning, the nozzle 70 moves linearly in the moving direction relative to the chassis 4, while performing a supplying operation to supply the fluid mixture from one end to the other end of the chassis 4, and such a supplying operation is performed five (5) times by changing the position of the nozzle 70 at 20 mm intervals in the direction perpendicular to the moving direction. In addition, every time one cleaning ends, the rotor 6 is turned 90° (clockwise in this example), before starting the next cleaning, as illustrated in FIG. 10.

Hence, according to the practical example Emb2, the chassis 4 and the entire rotor 6 are cleaned by the cleaning method A described above in conjunction with FIG. 7, and the rotor 6 is thereafter cleaned by the cleaning method B described above in conjunction with FIG. 10 by blowing the fluid mixture onto the rotor 6 from different directions, in order to improve the cleanliness of particularly the rotor 6.

In this practical example Emb2, the angle e illustrated in FIG. 4 of the nozzle 70 is 45°, a distance between the nozzle 70 and the chassis 4 is 20 mm, a supplying width (for example, spraying width) of the nozzle 70 is 50 mm, the flow rate of the fluid mixture supplied from the nozzle 70 is 300 L/min, the gas (or air) pressure of the gas supplied from the compressor 76 is 0.5 MPa, and the temperature of the fluid mixture supplied onto the chassis 4, the rotor 6, or the like is in a range of 78° C. to 80° C., similarly as in the case of the practical example Emb1 described above.

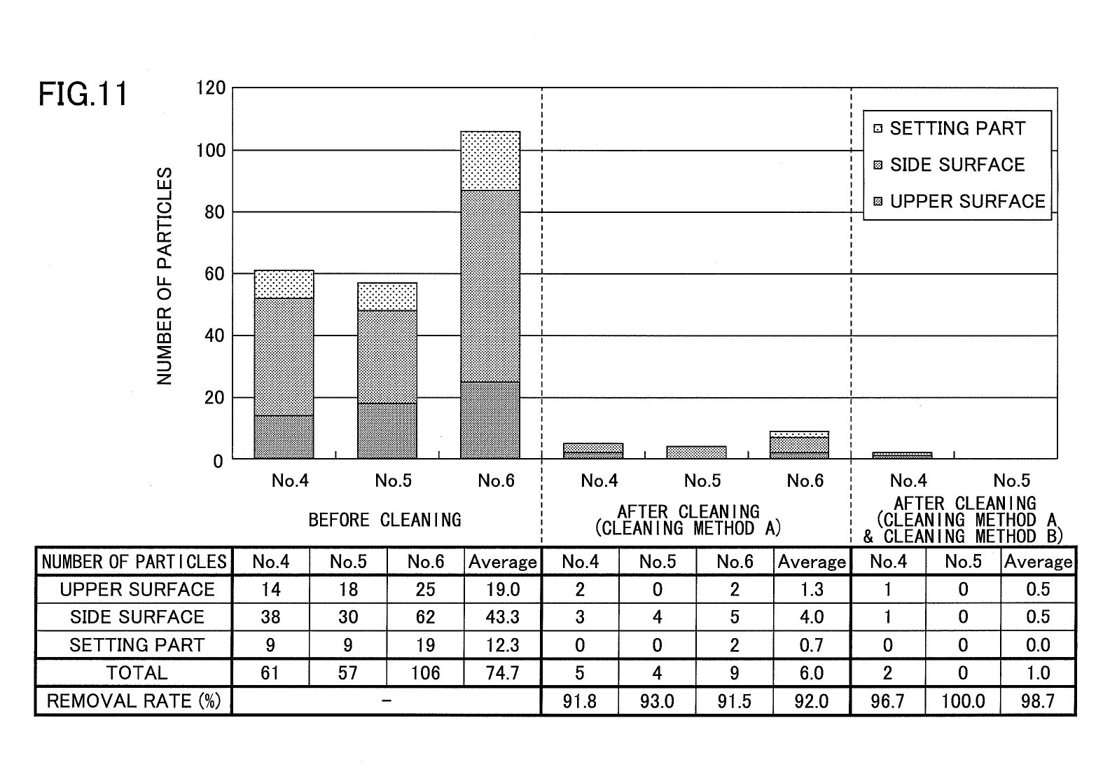

FIG. 11 is a diagram illustrating an example of cleaning results in the practical example Emb2.

FIG. 11 illustrates, for sample No. 4, sample No. 5, and sample No. 6, the number of foreign particles adhered thereon before the cleaning, after the cleaning using the cleaning method A described above in conjunction with FIG. 7, and after the further cleaning using the cleaning method B described above in conjunction with FIG. 10. Each of the sample Nos. 4 through 6 correspond to the hub 28.

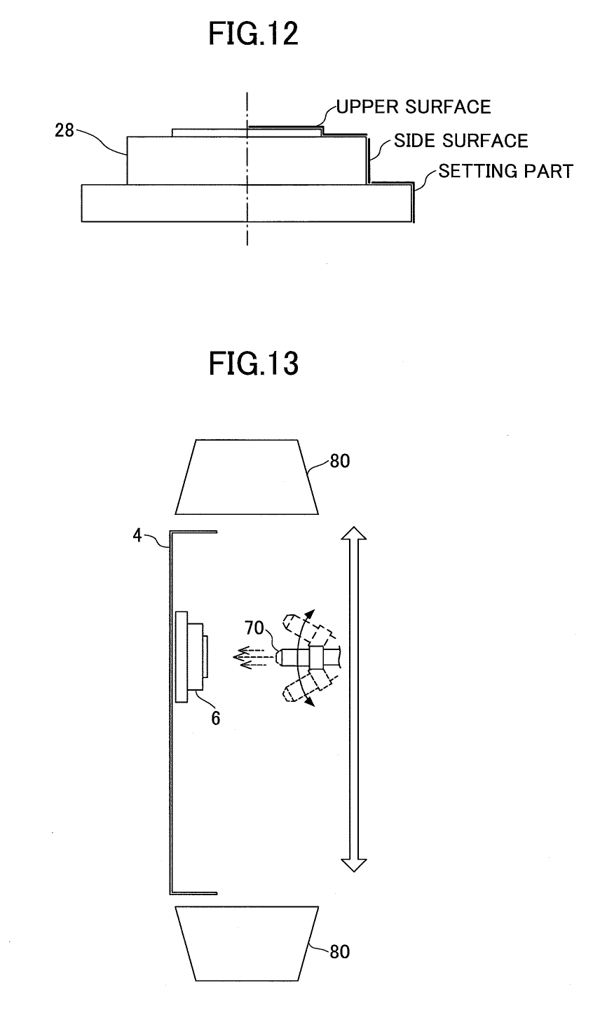

The number of foreign particles indicated in the cleaning results are obtained by counting the number of foreign particles at each of the upper surface and the side surface of the hub 28, and the setting part of the hub 28 where the magnetic recording disk 8 is to be set, as illustrated in FIG. 12, in order to study the effects of cleaning particularly the hub 28 of the rotor 6. FIG. 12 is a diagram for explaining locations of each of parts included in the cleaning results illustrated in FIG. 11.

As illustrated in FIG. 12, the total number of foreign particles on an average is 74.7 (upper surface: 19, side surface: 43.3, setting part: 12.3) for each of the sample Nos. 4 through 6 before the cleaning. On the other hand, the total number of foreign particles on an average is 6 (upper surface: 1.3, side surface: 4, setting part: 0.7) for each of the sample Nos. 4 through 6 after the cleaning using the cleaning method A illustrated in FIG. 7, and the number of foreign particles is reduced after this cleaning. In addition, the total number of foreign particles on an average is 1 (upper surface: 0.5, side surface: 0.5, setting part: 0) for each of the sample Nos. 4 through 6 after the cleaning using the cleaning method B illustrated in FIG. 10, and the number of foreign particles is further reduced after this cleaning which is performed after the cleaning using the cleaning method A.

Hence, according to the practical example Emb2, the removal rate of the foreign particles adhered on each of the sample Nos. 4 through 6 is approximately 99%, and it is confirmed that the foreign particles adhered on the hub 28 are even more effectively removed and the cleanliness is improved.

As described above, according to the method of manufacturing the rotating device 100 in this embodiment, the chassis 4, the rotor 6, or the like are sealed in a state in which virtually all of the foreign particles such as dust adhered thereon are removed by the fluid mixture supplied from the nozzle 70. Hence, the foreign particles adhered on the constituent elements (that is, parts, components, or the like) of the rotating device 100 are removed, and the cleanliness of the inside of the rotating device 100 can be improved. As a result, the malfunction of the rotating device 100 caused by the foreign particles such as dust, including a read/write error from/to the magnetic recording disk 8, can be reduced.

The number of nozzles 70 provided, the position where the nozzle 70 is arranged, and the direction in which the fluid mixture is supplied from the nozzle 70 are not limited to those of the configuration described above, and may be appropriately modified according to the configurations of the chassis 4, the rotor 6, or the like. For example, a minimum distance between the nozzle and a cleaning target which is to be cleaned may be set in a range of 5 mm or greater and 60 mm or less, for example. In addition, the cleaning method for the chassis 4, the rotor 6, or the like is not limited to the methods of the practical examples Emb1 and Emb2 described above. For example, the number of times the cleaning is performed, the number of times the supplying operation is performed to supply the fluid mixture, the direction in which the fluid mixture is supplied, the moving direction of the chassis 4 and/or the nozzle 70 may be appropriately modified according to the desired removal rate of the foreign particles. Further, the cleaning may be performed while continuously rotating the rotor 6, for example.

In the embodiment and the practical examples described above, the fluid mixture including the solidified carbon dioxide is supplied with respect to the chassis 4, the rotor 6, or the like from the nozzle 70 that moves relative to the chassis 4, the rotor 6, or the like. However, the configuration and/or arrangement of the nozzle 70 is not limited to such, and for example, the nozzle 70 may be provided at a predetermined fixed position with respect to the chassis 4, the rotor 6, or the like, in order to suppress the manufacturing facility from becoming large.

In the embodiment and the practical examples described above, the chassis 4, the rotor 6, or the like are cleaned in a state in which the rotational axis R is approximately parallel to the vertical direction. However, the orientation of the chassis 4, the rotor 6, or the like during the cleaning is not limited to such, and the chassis 4, the rotor 6, or the like may arranged in an arbitrary orientation during the cleaning. For example, the chassis 4, the rotor 6, or the like may be cleaned in a state in which the rotational axis R is approximately parallel to the horizontal direction, as illustrated in FIG. 13. FIG. 13 is a diagram schematically illustrating another example of the configuration of the cleaning apparatus. In this case, a suction opening of the particle collecting unit 80 may be provided on at least one of the upper side and the lower side, as illustrated in FIG. 13, in order to collect, under suction, a gas or gases in vicinities of the chassis 4 and the rotor part. In addition, the nozzle 70 may move in the up-and-down direction in FIG. 13, or swing in the up-and-down direction in FIG. 13. Alternatively, the nozzle 70 may swing while moving in the up-and-down direction in FIG. 13.

In the embodiment and the practical examples described above, the chassis 4 having the rotor 6 or the like assembled thereon is cleaned while being transported by the transport belt 60. However, the method of transporting or moving the chassis 4, the rotor 6, or the like is not limited to the method using the transport belt 60. For example, the chassis 4 having the rotor 6 or the like assembled thereon may be set on an index table, and the cleaning may be performed while being moved in accordance with the movement of the index table. In addition, the chassis 4 having the rotor 6 or the like assembled thereon may be set on a turntable, and the cleaning may be performed while being moved in accordance with the rotation of the turntable. Moreover, the chassis 4 having the rotor 6 or the like assembled thereon may be set on a robot arm, and the cleaning may be performed while being moved in accordance with the motion of the robot arm.

According to each of the embodiment and the practical examples, it is possible to further improve the cleanliness of the rotating device, by removing the foreign particles adhered on the components forming the rotating device.

Although the practical examples are numbered with, for example, “first,” or “second,” the ordinal numbers do not imply priorities of the practical examples.

Although the embodiments of the present invention have been described in detail, it should be understood that the various changes, substitutions, and alterations could be made hereto without departing from the spirit and scope of the invention.

What is claimed is:

1. A method of manufacturing a rotating device, comprising:
assembling a rotor part on a chassis in a rotatable manner;
supplying a fluid mixture including solidified carbon dioxide onto the rotor part and the chassis from a nozzle which moves relative to the chassis having the rotor part assembled thereon; and
packaging the chassis having the rotor part assembled thereon within a package after the supplying.

2. The method of manufacturing the rotating device as claimed in claim 1, wherein the supplying supplies the fluid mixture from the nozzle in a direction non-parallel and non-perpendicular with respect to a bottom surface of the chassis.

3. The method of manufacturing the rotating device as claimed in claim 1, wherein the supplying supplies the fluid mixture from the nozzle while changing a direction in which the fluid mixture is supplied from the nozzle.

4. The method of manufacturing the rotating device as claimed in claim 1, wherein the fluid mixture includes a heated gas.

5. The method of manufacturing the rotating device as claimed in claim 1, wherein the supplying includes collecting, under suction, a gas or gases in vicinities of the chassis and the rotor part.

6. The method of manufacturing the rotating device as claimed in claim 1, wherein the supplying performs a supplying operation a plurality of times, wherein the supplying operation includes supplying the fluid mixture while moving the nozzle in a relative moving direction with respect to the chassis.

7. The method of manufacturing the rotating device as claimed in claim 1, wherein the supplying includes
supplying the fluid mixture while moving the nozzle in a first relative moving direction with respect to the chassis, and
supplying the fluid mixture while moving the nozzle in a second relative moving direction, opposite to the first relative moving direction, with respect to the chassis.

8. The method of manufacturing the rotating device as claimed in claim 1, wherein the supplying supplies the fluid mixture while rotating the rotor part.

9. The method of manufacturing the rotating device as claimed in claim 1, wherein the supplying supplies the fluid mixture from a plurality of nozzles.

10. A method of manufacturing a rotating device, comprising:
assembling a rotor part on a chassis in a rotatable manner;
supplying a fluid mixture including solidified carbon dioxide onto the rotor part and the chassis from a nozzle which moves relative to the chassis having the rotor part assembled thereon; and
collecting, under suction, a gas or gases in vicinities of the chassis and the rotor part.

11. The method of manufacturing the rotating device as claimed in claim 10, wherein the supplying supplies the fluid mixture from the nozzle in a direction non-parallel and non-perpendicular with respect to a bottom surface of the chassis.

12. The method of manufacturing the rotating device as claimed in claim 10, wherein the supplying supplies the fluid mixture from the nozzle while changing a direction in which the fluid mixture is supplied from the nozzle.

13. The method of manufacturing the rotating device as claimed in claim 10, wherein the fluid mixture includes a heated gas.

14. The method of manufacturing the rotating device as claimed in claim 10, wherein the supplying performs a supplying operation a plurality of times, wherein the supplying operation includes supplying the fluid mixture while moving the nozzle in a relative moving direction with respect to the chassis.

15. The method of manufacturing the rotating device as claimed in claim 10, wherein the supplying includes
supplying the fluid mixture while moving the nozzle in a first relative moving direction with respect to the chassis, and
supplying the fluid mixture while moving the nozzle in a second relative moving direction, opposite to the first relative moving direction, with respect to the chassis.

16. The method of manufacturing the rotating device as claimed in claim 10, wherein the supplying supplies the fluid mixture while rotating the rotor part.

17. A method of manufacturing a rotating device, comprising:
assembling a rotor part on a chassis in a rotatable manner; and
supplying a fluid mixture including solidified carbon dioxide onto the rotor part and the chassis from a nozzle which moves relative to the chassis having the rotor part assembled thereon,
wherein the supplying supplies the fluid mixture while rotating the rotor part.

18. The method of manufacturing the rotating device as claimed in claim 17, wherein the supplying supplies the fluid mixture from the nozzle while changing a direction in which the fluid mixture is supplied from the nozzle.

19. The method of manufacturing the rotating device as claimed in claim 17, wherein the fluid mixture includes a heated gas.

20. The method of manufacturing the rotating device as claimed in claim 17, wherein the supplying includes collecting, under suction, a gas or gases in vicinities of the chassis and the rotor part.
